(19) United States
(12) Patent Application Publication
(10) Pub. No.: US 2026/0055244 A1
(43) Pub. Date: Feb. 26, 2026

(54) PREPARATION METHOD FOR SHEAR THICKENING FLUID AND USE OF FLUID

(71) Applicant: ZHONGSHAN LAIPU NEW MATERIALS CO., LTD, Guangdong (CN)

(72) Inventors: Gannian ZHANG, Guangdong (CN); Zhengbing SHI, Guangdong (CN)

(73) Assignee: ZHONGSHAN LAIPU NEW MATERIALS CO., LTD, Guangdong (CN)

(21) Appl. No.: 19/103,239

(22) PCT Filed: Jul. 24, 2023
(86) PCT No.: PCT/CN2023/108879

§ 371 Date: Feb. 12, 2025

(30) Foreign Application Priority Data
Aug. 19, 2022 (CN) 202210997861.6

(51) Int. Cl. C08J 3/21; C08K 3/26; C08K 7/18; C08L 71/02; C09C 3/04; C09C 3/08

(52) U.S. Cl. CPC C08J 3/212; C08K 3/26; C08K 7/18; C08L 71/02; C09C 3/043; C09C 3/08; C01P 2004/32; C01P 2004/64; C01P 2006/22; C08J 2371/02; C08K 2003/265; C08K 2201/011; C08L 2201/56

(57) ABSTRACT

Disclosed in the present invention are a preparation method for a shear thickening fluid and a use of the fluid. The preparation of the fluid comprises: first dispersing nanoparticles in a micromolecular alcohol pretreatment solvent, then centrifuging and freeze-drying to obtain freeze-dried powder, slowly adding the nanoparticle freeze-dried powder into polyhydric alcohol, slowly stirring and mixing until no macroscopic lump exists, then uniformly mixing by using a vortex oscillator or a bottle rolling machine to prepare a fluid with good uniformity, and finally drying and removing impurities to make the total content of water and micromolecular alcohol impurities not exceed 4 wt %, thereby obtaining a shear thickening fluid.

### TECHNICAL FIELD

The present invention relates to a preparation method for a shear thickening fluid and a use of the fluid and belongs to the field of nanofluid material technology.

### DESCRIPTION OF RELATED ART

A shear thickening fluid is a stable particle suspension composed of nanoparticles and solvent. When an external force acts on the fluid, the particles aggregate to form particle clusters, and the fluid viscosity increases exponentially with the formation of particle clusters. When the external force is removed, the particle clusters dissociate, the particles return to the dispersed suspended state, and the fluid viscosity also decreases to an equilibrium state. This feature enables the fluid to absorb and dissipate a large amount of external impact energy and makes it have potential application market in many fields such as stab resistance, bullet resistance, and impact resistance. In addition, the formation and dissociation of particle clusters do not require the aid of external force fields (electric field, magnetic field, etc.).

The fluid concentration of the shear thickening fluid is expressed by the volume fraction φ of nanoparticles most of the time. Only when φ reaches a specific critical value, the concentration of the fluid may increase abruptly under high shear stress, exhibiting the effect of “discontinuous shear thickening”. However, the process of preparing high-concentration shear thickening fluid is relatively complicated, and the efficiency is relatively low.

### SUMMARY

The present invention aims to solve the deficiencies in the related art and provide a preparation method for a shear thickening fluid through which a fluid prepared by this method with a concentration of 0.30 to 0.55 features discontinuous shear thickening and considerable promotional value.

The present invention also aims to provide a use of the fluid prepared by the aforementioned method.

The present invention is achieved through the following technical solutions:

A preparation method for a shear thickening fluid is characterized in that the following steps are included:
a. Pretreatment of nanoparticles: The nanoparticles are dispersed in a micromolecular alcohol pretreatment solvent and then centrifuged and freeze-dried, and freeze-dried powder is obtained.
b. Nanoparticle pre-mixing: The nanoparticle freeze-dried powder is slowly added into polyhydric alcohol and slowly stirred and mixed until no macroscopic lump exists, and an initial fluid is obtained.
b. Initial fluid mixing and dispersing: The initial fluid is mixed with a vortex oscillator or a bottle rolling machine, and a fluid with good uniformity is obtained. The fluid is not locally stratified when it flows.
d. Impurity removal: The fluid is vacuum dried so that a total content of water and micromolecular alcohol impurities does not exceed 4 wt %, and a shear thickening fluid is obtained.

In the present invention, the nanoparticles are ultrasonically dispersed in a pretreatment solvent during pretreatment of the nanoparticles.

In the present invention, the nanoparticles are one of nano-silicon dioxide spheres, light calcium carbonate powder, and nano-cellulose crystals.

In the present invention, the polyhydric alcohol is a liquid polyhydric alcohol having a viscosity of 10 mPa·s to 130 mPa·s at 20° C., preferably polyethylene glycol with a relative molecular mass of 100, 200, 300, or 400.

In the present invention, the pretreatment solvent is one or a mixture of several of ethanol, methanol, n-butanol, and isobutanol. Micromolecular alcohol pretreatment solvents are able to adsorb on the surface of most particles through van der Waals forces, and the molecules of micromolecular alcohols are relatively small. When the fluid undergoes shear thickening under high shear stress, nanoparticles rub against each other, which is a rigid friction. Due to their small size, micromolecular alcohols do not affect the rigid contact, and therefore, the shear thickening property of the fluid is pronounced. However, if slightly larger molecules such as coupling agents are used, the rigid contact between particles is affected, and the shear thickening property does not be as pronounced. Further, the boiling points of micromolecular alcohols are generally below 120° C., and they are able to evaporate rapidly when heated to 90° C. to 105° C. This makes it easy to control the content of micromolecular alcohols in the fluid, while ensuring that the polyhydric alcohol does not oxidize due to excessively high heating temperatures. The discontinuous shear thickening characteristic of the fluid is thereby enhanced.

In step b of the present invention, the amount of pretreated nanoparticles added each time increases the fluid concentration by 1% to 5%. Initially, a slightly larger amount of nanoparticles is added to the solvent, as the concentration is lower at this time, making it easier to be uniformly mixed. As the nanoparticles are gradually increased, the concentration of the mixed liquid also gradually increases. At this point, the amount of nanoparticles added per batch can be gradually reduced to ensure the mixing effect.

A use of the shear thickening fluid prepared by the aforementioned method is characterized in that it is used in composite stab-resistant materials or impact protection bodies.

Compared to the related art, the present invention has the following advantages:

The preparation method of the present invention has simple steps and is easy to control, and the prepared shear thickening fluid has the characteristic of discontinuous shear thickening when the fluid has a concentration of 0.30-0.55.

### BRIEF DESCRIPTION OF THE DRAWINGS

FIG. 1 is a graph of a relationship of viscosity change with shear rate of fluids of Embodiment 1 and Comparative example 1.

FIG. 2 is a graph of a relationship of viscosity change with shear rate of a fluid with φ=0.49 of Embodiment 2.

FIG. 3 is a graph of a relationship of viscosity change with shear rate of a fluid with φ=0.30 of Embodiment 3.

FIG. 4 is a graph of a relationship of viscosity change with shear rate of a fluid with φ=0.36 of Embodiment 4.

FIG. 5 is a graph of a relationship of viscosity change with shear rate of a fluid with φ=0.44 of Embodiment 5.

### DESCRIPTION OF THE EMBODIMENTS

A preparation method for a shear thickening fluid includes the following steps:
a. Pretreatment of nanoparticles: The nanoparticles are dispersed in a micromolecular alcohol pretreatment solvent and then centrifuged and freeze-dried, and freeze-dried powder is obtained.
b. Nanoparticle pre-mixing: The nanoparticle freeze-dried powder is slowly added into polyhydric alcohol and slowly stirred and mixed until no macroscopic lump exists, and an initial fluid is obtained.
b. Initial fluid mixing and dispersing: The initial fluid is mixed with a vortex oscillator or a bottle rolling machine, and a fluid with good uniformity is obtained.
d. Impurity removal: The fluid is vacuum dried so that a total content of water and micromolecular alcohol impurities does not exceed 4 wt %.

The nanoparticles may be nano-silicon dioxide spheres, light calcium carbonate powder, or nano-cellulose crystals. The micromolecular alcohol pretreatment solvent may be one or a mixture of several of ethanol, methanol, n-butanol, and isobutanol. The polyhydric alcohol may be a liquid polyhydric alcohol having a viscosity of 10 mPa·s to 130 mPa·s (20° C.).

The present invention is further described together with specific embodiments in the following paragraphs.

### Embodiment 1

To prepare a shear thickening fluid with a concentration φ=0.52, a raw material is silicon dioxide spheres with a particle diameter of 500 nm±27 nm, the pretreatment solvent is a mixed solvent with a mass ratio of ethanol to n-butanol of 4:1, and the polyhydric alcohol is polyethylene glycol with a relative molecular weight of 200. The preparation method is as follows:
a. Pretreatment of nanoparticles: Silica spheres and a pretreatment solvent are mixed in a probe-type ultrasonic crusher at 20 kHz with a Tₒₙ/T_{off} setting of 8 s/5 s for 3 hours to obtain a pretreatment dispersion of silica spheres with a concentration of approximately 35 wt %. The pretreated dispersion is centrifuged at 20,000 RPM for 2 hours to obtain a silica sphere sediment layer, which is crushed and freeze-dried, and freeze-dried powder is obtained.
b. Nanoparticle pre-mixing: The freeze-dried powder is slowly added to polyhydric alcohol and is slowly stirred and mixed until no macroscopic lump exists. An amount of freeze-dried powder added each time increases a fluid concentration by 2%. An initial fluid is obtained.
c. Initial fluid mixing and dispersing: After the initial fluid is sealed, the initial fluid is mixed with a vortex oscillator or a bottle rolling machine for 5 to 7 days, and a fluid with good uniformity is obtained. Good uniformity means that the fluid is not locally stratified when it flows and has a strong “Tyndall effect”.
d. Impurity removal: The fluid is vacuum dried at 85° C. for 8 hours to ensure that a total content of water and micromolecular alcohol impurities does not exceed 4 wt %.

### Comparative Example 1

To prepare a fluid with a concentration φ=0.52, the raw material is silica spheres with a particle size of 500 nm±27 nm, and the polyhydric alcohol is polyethylene glycol with a relative molecular mass of 200. The preparation method is as follows:
a. Nanoparticle pre-mixing: The silica spheres are slowly added to the polyhydric alcohol and are slowly stirred and mixed until no 1 macroscopic lump exists. The amount of nanoparticles added each time increases the fluid concentration by 2%. An initial fluid is obtained.
b. Initial fluid mixing and dispersing: After the initial fluid is sealed, the initial fluid is mixed with a vortex oscillator or a bottle rolling machine for 5 to 7 days, and a control fluid is obtained. This fluid is not very uniform, is similar to a smoothie, and has a granular feel.
c. Impurity removal: The control fluid is vacuum dried at 85° C. for 8 hours to ensure that the total content of water and micromolecular alcohol impurities does not exceed 4 wt %.

Even if the mixing time is extended to 13 to 15 days, the granular feel of the control fluid cannot be eliminated.

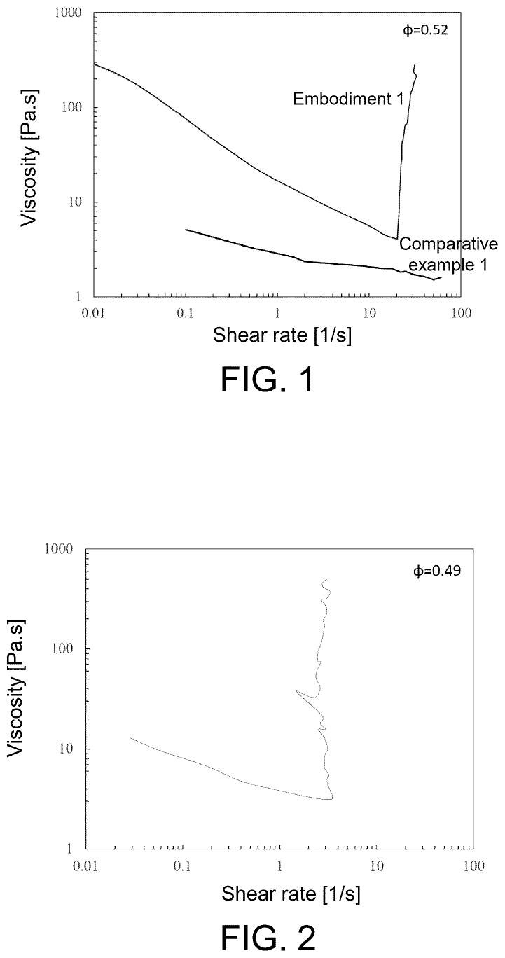

The rheological properties of the fluids of Embodiment 1 and Comparative example 1 are tested using a rheometer (MCR302, Anton Paar). To more accurately reflect the changes in fluid viscosity under high shear stress conditions, the stress control mode of the rheometer is used, scanning over a stress range of 10⁻² Pa to 10³ Pa, and the results are presented in a traditional log-log “viscosity-shear rate” graph, as shown in FIG. 1. Although both fluids have a concentration of 0.52, the viscosity-shear rate curve of the fluid produced with untreated silicon dioxide spheres is not smooth and shows no significant increase in viscosity, indicating that the silica spheres are not well dispersed in the polyethylene glycol. Further, when the test stress exceeds 55 Pa, in the stress control mode, the rheometer is forced to terminate the test as it cannot detect excessively small changes in the fluid's viscosity. In contrast, the fluid produced with the pretreated silicon dioxide spheres exhibits a jump in viscosity at a shear rate of 20 s⁻¹. Not only does the viscosity increase greatly, but as the viscosity increases, the shear rate itself remains basically unchanged, demonstrating a typical discontinuous shear thickening characteristic.

Experiments have demonstrated that if a surface of the nanoparticles is covered with micromolecular alcohols, the nanoparticles can be dispersed in the polyhydric alcohol simply by mixing, and the formulated fluid may have discontinuous shear thickening properties within the range of φ=0.30 to 0.55. However, if the particle surface is not covered with micromolecular alcohols, the discontinuous shear thickening properties can only be achieved when φ≥0.62.

### Embodiment 2

To prepare a shear thickening fluid with a concentration of φ=0.49, the raw material is light calcium carbonate particles with a particle size of 873 nm±58 nm, the pretreatment solvent is a mixed solvent of methanol and n-butanol with a mass ratio of 5:2, and the polyhydric alcohol is polyethylene glycol with a relative molecular mass of 200. The preparation method for the fluid is as follows:
a. Pretreatment of nanoparticles: A probe ultrasonic crusher is used, and at a frequency of 20 kHz with the crusher setting Tₒₙ/T_{off} of 3 s/2 s, the light calcium carbonate particles are mixed with the pretreatment solvent for 2.5 hours, and a 35 wt % nanoparticle pretreatment dispersion is obtained. The pre-treated dispersion is ultra-centrifuged at 20,000 RPM for 2 hours to obtain a silica sphere sediment layer, which is crushed and freeze-dried, and freeze-dried powder is obtained.
b. Nanoparticle pre-mixing: Light calcium carbonate particle freeze-dried powder is slowly added into polyethylene glycol with a relative molecular mass of 200 and is slowly stirred and mixed until no macroscopic lump exists. The amount of light calcium carbonate particle freeze-dried powder added each time increases the fluid concentration by 1.5%. An initial fluid is obtained.
c. Initial fluid mixing and dispersing: The initial fluid is sealed in a container and placed on a vortex oscillator or a bottle rolling machine for mixing for 5 to 7 days until it flows without local stratification and has a strong “Tyndall effect”, and a fluid with good uniformity is thus obtained.
d. Impurity removal: The fluid is vacuum dried at 90° C. for 7.5 hours to ensure that the total content of water and micromolecular alcohol impurities does not exceed 4 wt %.

According to the method of Embodiment 1, the rheological properties of the fluid in Embodiment 2 are tested, and the results are shown in FIG. 2, which displays the relationship of viscosity change with shear rate. This fluid exhibits a strong discontinuous shear thickening property as the viscosity increases abruptly while the shear rate remains essentially constant at approximately 4 s⁻¹.

### Embodiment 3

To prepare a shear thickening fluid with a concentration of φ=0.30, the raw material is nanocellulose crystal with a particle size of 942 nm±75 nm, the pretreatment solvent is a mixed solvent with a mass ratio of ethanol and isobutanol of 4:1, and the polyhydric alcohol is polyethylene glycol with a relative molecular mass of 100. The preparation method for the fluid is as follows:
a. Pretreatment of nanoparticles: A high-speed disperser is used, and at a speed of 3500 RPM, the nanocellulose crystals are mixed with a pretreatment solvent for 3.5 hours, and a 20 wt % nanocellulose crystal pretreatment dispersion is obtained. The pre-treated dispersion is ultra-centrifuged at 16,000 RPM for 2 hours to obtain a crystal sediment layer, which is crushed and freeze-dried, and crystal freeze-dried powder is obtained.
b. Nanoparticle pre-mixing: Crystalline freeze-dried powder is slowly added into polyethylene glycol with a relative molecular mass of 100 and is slowly stirred and mixed until no macroscopic lump exists. The amount of crystalline freeze-dried powder added each time increases the fluid concentration by 1.0%. An initial fluid is obtained.
c. Initial fluid mixing and dispersing: The initial fluid is sealed in a container and placed on a vortex oscillator or a bottle rolling machine for mixing for 5 to 7 days until the fluid flows without local stratification and has a strong “Tyndall effect”, and a fluid with good uniformity is thus obtained.
d. Impurity removal: The fluid is vacuum dried at 90° C. for 7.5 hours to ensure that the total content of water and micromolecular alcohol impurities does not exceed 4 wt %.

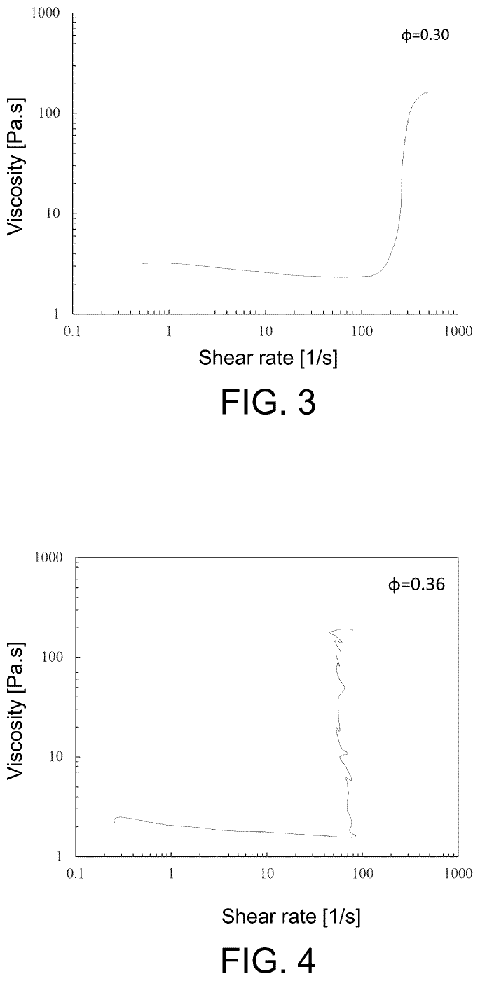

According to the method of Embodiment 1, the rheological properties of this fluid are tested, and the results are shown in FIG. 3. From the relationship between viscosity and shear rate, it may be observed that the fluid exhibits a relatively strong discontinuous shear thickening characteristic.

### Embodiment 4

To prepare a shear thickening fluid with a concentration of φ=0.36, the raw material is calcium carbonate powder with a particle size of 942 nm±75 nm, the pretreatment solvent is ethanol, and the polyhydric alcohol is polyethylene glycol with a relative molecular mass of 200. The preparation method for the fluid is as follows:
a. Pretreatment of nanoparticles: A probe ultrasonic crusher is used, and at a frequency of 15 kHz with the crusher setting Tₒₙ/T_{off} of 5 s/3 s, calcium carbonate powder is mixed with ethanol for 4 hours to prepare a pretreatment dispersion with a calcium carbonate powder content of 25 wt %. The pre-treated dispersion is ultra-centrifuged at 16,000 RPM for 2 hours to obtain a particle sediment layer, which is crushed and freeze-dried, and freeze-dried powder is obtained.
b. Nanoparticle pre-mixing: The pre-treated freeze-dried powder is slowly added into polyethylene glycol with a relative molecular mass of 200 and is slowly stirred and mixed until no macroscopic lump exists. The amount of freeze-dried powder added each time increases the fluid concentration by 1.0%. An initial fluid is obtained.
c. Initial fluid mixing and dispersing: The initial fluid is sealed in a container and placed on a vortex oscillator or a bottle rolling machine for mixing for 5 to 7 days until the fluid flows without local stratification and has a strong “Tyndall effect”, and a fluid with good uniformity is thus obtained.
d. Impurity removal: The fluid is vacuum dried at 90° C. for 7.5 hours to ensure that the total content of water and micromolecular alcohol impurities does not exceed 4 wt %.

According to the method of Embodiment 1, the rheological properties of the fluid is tested, and the results are presented as the relationship between viscosity and shear rate, as shown in FIG. 4. The fluid exhibits a strong discontinuous shear thickening property.

### Embodiment 5

To prepare a shear thickening fluid with a concentration of φ=0.44, the raw material is nano-silica spheres with a particle size of 104 nm±12 nm., the pretreatment solvent is a mixed solvent with a mass ratio of ethanol and isobutanol of 3:1, and the polyhydric alcohol is polyethylene glycol with a relative molecular mass of 200. The preparation method for the fluid is as follows:
a. Pretreatment of nanoparticles: A probe ultrasonic crusher is used, and at a frequency of 20 kHz with the crusher setting Tₒₙ/T_{off} of 5 s/5 s, the nano-silica spheres are mixed with the pretreatment solvent for 4 hours, and a pretreatment dispersion having a nano-silica sphere content of approximately 20 wt % is obtained. The pre-treated dispersion is centrifuged at high speed at 16,000 RPM for 2 hours to obtain a silica sphere sediment layer, which is crushed and freeze-dried, and freeze-dried powder is obtained.
b. Nanoparticle pre-mixing: The freeze-dried powder is slowly added into polyethylene glycol with a relative molecular mass of 200 and is slowly stirred and mixed until no macroscopic lump exists. The amount of freeze-dried powder added each time increases the fluid concentration by 1.0%. An initial fluid is obtained.
c. Initial fluid mixing and dispersing: The initial fluid is sealed in a container and placed on a vortex oscillator or a bottle rolling machine for mixing for 5 to 7 days until the fluid flows without local stratification and has a strong “Tyndall effect”, and a fluid with good uniformity is thus obtained.
d. Impurity removal: The fluid is vacuum dried at 80° C. for 8 hours to ensure that the total content of water and micromolecular alcohol impurities does not exceed 4 wt %.

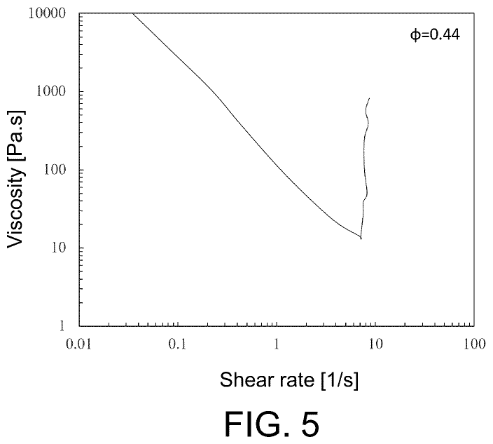

According to the method of Embodiment 1, the rheological properties of the fluid are tested, and the results are presented in the form of viscosity vs. shear rate, as shown in FIG. 5. From the curve in the figure, it may be observed that the fluid exhibits a strong discontinuous shear thickening property.

1. A preparation method for a shear thickening fluid, comprising the following steps:
a. pretreating nanoparticles: dispersing the nanoparticles in a micromolecular alcohol pretreatment solvent, performing centrifuging and freeze-drying, and obtaining freeze-dried powder;
b. pre-mixing the nanoparticles: slowly adding the nanoparticle freeze-dried powder into polyhydric alcohol, performing stirring and mixing slowly until no macroscopic lump exists, and obtaining an initial fluid;
c. mixing and dispersing the initial fluid: mixing the initial fluid with a vortex oscillator or a bottle rolling machine and obtaining a fluid with good uniformity; and
d. removing impurities: vacuum drying the fluid so that a total content of water and micromolecular alcohol impurities does not exceed 4 wt %.

2. The preparation method for the shear thickening fluid according to claim 1, wherein the nanoparticles are ultrasonically dispersed in a pretreatment solvent during pretreatment of the nanoparticles.

3. The preparation method for the shear thickening fluid according to claim 1, wherein the nanoparticles are one of nano-silicon dioxide spheres, light calcium carbonate powder, and nano-cellulose crystals.

4. The preparation method for the shear thickening fluid according to claim 1, wherein the polyhydric alcohol is a liquid polyhydric alcohol having a viscosity of 10 mPa·s to 130 mPa·s at 20°C.

5. The preparation method for the shear thickening fluid according to claim 1, wherein the pretreatment solvent is one or a mixture of several of ethanol, methanol, n-butanol, and isobutanol.

6. The preparation method for the shear thickening fluid according to claim 1, wherein in the step b, an amount of pretreated nanoparticles added each time increases a fluid concentration by 1% to 5%.

7. A method of using use of the shear thickening fluid prepared through the method according to claim 1.
